(19) United States
(12) Patent Application Publication
(10) Pub. No.: US 2024/0326845 A1
(43) Pub. Date: Oct. 3, 2024

(54) VEHICLE MONITORING AND SENSOR CALIBRATION TRIGGERING SYSTEM

(71) Applicant: Mercedes-Benz Group AG, Stuttgart (DE)

(72) Inventor: Sneha Sudhir Shetiya, Sunnyvale, CA (US)

(21) Appl. No.: 18/128,569

(22) Filed: Mar. 30, 2023

(51) Int. Cl. B60W 50/04; B60W 50/14

(52) U.S. Cl. CPC B60W 50/04; B60W 50/14; B60W 2050/0083; B60W 2050/146; B60W 2420/403; B60W 2420/408

(57) ABSTRACT

A vehicle computing system can monitor a vehicle using one or more sensors based on a set of sensor calibration triggers. Based on monitoring the vehicle, the computing system can detect a sensor calibration trigger of the set of sensor calibration triggers. In response to detecting the sensor calibration trigger, the computing system can output a recalibration alert to a user, where the recalibration alert notifies the user to recalibrate a sensor system of the vehicle.

### BACKGROUND

Sensor systems of autonomous and semi-autonomous vehicles are used for providing alerts (e.g., lane drifting alerts, collision warning, etc.), performing emergency interventions, driver assistance actions (e.g., automatic parallel parking, lane following and centering, etc.), or for automated navigation and control of the vehicle through a road network. These actions require the sensors of the vehicle to be calibrated appropriately.

### SUMMARY

A computing system for a vehicle can monitor the vehicle using one or more sensors based on a set of sensor calibration triggers. Based on monitoring the vehicle, the computing system can detect a sensor calibration trigger of the set of sensor calibration triggers, and output a recalibration alert to a user (e.g., a passenger or driver of the vehicle). The recalibration alert can notify the user to recalibrate a sensor system of the vehicle. As provided herein, each sensor calibration trigger of the set of sensor calibration triggers can correspond to a severity level that indicates whether one or more sensors of the sensor system requires a full recalibration (e.g., extrinsic calibration or intrinsic calibration), an adjustment, a repositioning, and/or needs to be replaced. In certain examples, the calibration alert can be provided on a display screen of the vehicle (e.g., on the dashboard or infotainment system). In variations, the sensor calibration alert can be transmitted to a computing device of the user.

In certain implementations, the computing system monitors the vehicle using one or more inertial measurement units (IMUs). As such, the computing system can monitor the vehicle for shocks, vibrations, and other forces of varying severity that may cause sensor orientation changes, damage to sensor mounts, or damage to the sensors themselves. Such shocks, vibrations, and other forces can correspond to the vehicle going over bumps or potholes on a road, the vehicle experiencing a collision event, severe acceleration or braking events, lateral forces exceeding one or more thresholds, and the like.

In various examples, the sensor system of the vehicle can include any combination of one or more LIDAR sensors, one or more image sensors, one or more radar sensors, or one or more ultrasonic sensors. Such sensor may be required for fully autonomous or semi-autonomous vehicle operation. For example, an on-board computing system of the vehicle may execute a set of perception, motion prediction, motion planning, and/or motion execution models based on sensor data from the sensor system to autonomously or semi-autonomously navigate throughout a road network. These sensor-based models may be executed with reliance on the calibration of the sensor system (e.g., with respect to the vehicle's center). In certain examples, the computing system can further monitor the vehicle based on the sensor data from the vehicle's sensor system.

According to examples described herein, the set of triggers can correspond to a set of scenarios, which can comprise windshield breakage, windshield replacement, a shock or vibration experienced by the vehicle (e.g., exceeding one or more force or jolt thresholds), an over-the-air update to software, a hardware upgrade, a hardware downgrade, a component adjustment or modification, or a component replacement. The hardware downgrades or upgrades can correspond to computing hardware (e.g., increasing computing power) or sensors (e.g., less costly LIDAR or image sensors). The components can correspond to vehicle parts (e.g., parts that include sensors), such as rearview mirror, side mirrors, bumpers, wheels and/or tires, brakes, and the like.

In various implementations, the computing system can detect differing sensor calibration triggers of varying severity that can require intrinsic and/or extrinsic recalibrations of the sensor(s). As provided herein, intrinsic calibration can correspond to adjustments to the internal characteristics of the sensor, such as focal length, skew, distortion, image center, laser alignments, mirror position, photo-diode or light detector position, and the like. Extrinsic calibration can correspond to the position and orientation of the sensor in relation to other sensors, the center of the vehicle, and/or the surrounding environment. In certain examples, the computing system can determine that a sensor requires an adjustment to an intrinsic parameter, which may be recalibrated automatically. For example, the computing system can detect a sensor calibration trigger that corresponds to an intrinsic recalibration of a sensor. In response to detecting this calibration trigger, the computing system can transmit a calibration command to the sensor to cause the sensor to perform the intrinsic recalibration.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system for implementing vehicle monitoring and sensor recalibration alerts, according to examples described herein;

FIG. 2 is a block diagram illustrating an example vehicle computing system including specialized modules for implementing vehicle monitoring and sensor recalibration alerts, according to examples described herein;

FIGS. 3A and 3B illustrate example recalibration triggers, according to examples described herein; and

FIGS. 4 and 5 are flow charts describing example methods of implementing vehicle monitoring and sensor recalibration alerts, according to examples described herein.

### DETAILED DESCRIPTION

Electric and electronic (E/E) components of a vehicle can be included in safety systems that rely on sensing the external and/or internal vehicle environment to build situational awareness. The intended functionality and the implementation of E/E components for a particular safety system can cause hazardous behavior, despite these E/E components being relatively free from faults addressed in the ISO 26262 series. Certain examples of this potentially hazardous behavior include, for example, the inability of the safety system to correctly perceive the environment, the lack of robustness of the safety system's function or algorithm (e.g., with respect to sensor input variations), heuristics used for sensor fusion, the diversity of environmental conditions, or unexpected behavior of the safety system due to the decision-making algorithm and/or divergent human expectations.

The “safety of intended functionality” (SOTIF) corresponds to the absence of unreasonable risk due to a hazard caused by functional insufficiencies. This includes the insufficiencies of specification of the intended functionality of a safety system at the vehicle level, as well as the insufficiencies of specification or performance insufficiencies in the implementation of E/E components in the safety system. Accordingly, SOTIF mitigation measures correspond to the implementation of a particular safety system when the combination of a detected vehicular hazard (e.g., a failed component, tire slippage, etc.) and the present driving scenario (e.g., rainy conditions, dense traffic, high speed, etc.) generally create a risk of injury or loss of life and the controllability of the vehicle or safety system by the driver is not likely to prevent such injury or loss of life.

Measures to eliminate hazards or reduce risk are implemented in various phases of a vehicle safety system, including the specification and design phase, the verification and validation phase, and the operational phase of the system. In particular, (i) the modification of vehicle functionality and/or of sensor performance requirements driven by identified system insufficiencies or by hazardous scenarios in the development phase, (ii) in-loop testing of a safety system in selected SOTIF related scenarios (e.g., simulation of potential triggering conditions), and (iii) long-term vehicle testing, track testing, simulation testing, and field monitoring of real-world SOTIF incidences are all examples of such measures to eliminate hazards or reduce risk when addressing the SOTIF of a particular safety system. As provided herein, each potential hazard event is assessed in terms of severity of possible injuries within the context how much of the time a vehicle is exposed to the possibility of the hazard happening, as well as the relative likelihood that a typical driver can control the vehicle to prevent the injury.

Automotive safety integrity level (ASIL) is a risk classification scheme defined by ISO 26262 (the functional safety for road vehicles standard), and is typically established for the E/E components of the vehicle by performing a risk analysis of potential hazards, which involves determining respective levels of severity (i.e., the severity of injuries the hazard can be expected to cause; classified between S0 (no injuries) and S3 (life-threatening injuries)), exposure (i.e., the relative expected frequency of the operational conditions in which the injury can occur; classified between E0 (incredibly unlikely) and E4 (high probability of injury under most operating conditions)), and controllability (i.e., the relative likelihood that the driver can act to prevent the injury; classified between CO (controllable in general) and C3 difficult to control or uncontrollable)) of the vehicle operating scenario. As such, the safety goal(s) for any potential hazard event includes a set of ASIL requirements.

Hazards that are identified as quality management (QM) do not dictate any safety requirements. As an illustration, these QM hazards may be any combination of low probability of exposure to the hazard, low level of severity of potential injuries resulting from the hazard, and a high level of controllability by the driver in avoiding the hazard and/or preventing injuries. Other hazard events are classified as ASIL A, ASIL B, ASIL C, or ASIL D depending on the various levels of severity, exposure, and controllability corresponding to the potential hazard. ASIL D events correspond to the highest integrity requirements (ASIL requirements) on the safety system or E/E components of the safety system, and ASIL A comprises the lowest integrity requirements. As an example, the airbags, anti-lock brakes, and power steering system of a vehicle will typically have an ASIL D grade, where the risks associated with the failure of these components (e.g., the probable severity of injury and lack of vehicle controllability to prevent those injuries) are relatively high.

As provided herein, the ASIL may refer to both risk and risk-dependent requirements, where the various combinations of severity, exposure, and controllability are quantified to form an expression of risk (e.g., an airbag system of a vehicle may have a relatively low exposure classification, but high values for severity and controllability). As provided above, the quantities for severity, exposure, and controllability for a given hazard are traditionally determined using rudimentary levels for severity (e.g., S0 through S3), exposure (e.g., E0 through E4), and controllability (e.g., CO through C3) in the ISO 26262 series, where these values are then utilized to classify the ASIL requirements for the components of a particular safety system. As provided herein, certain safety systems can perform variable mitigation measures, which can range from alerts (e.g., visual, auditory, or haptic alerts), minor interventions (e.g., brake assist or steer assist), to major interventions and/or avoidance maneuvering (e.g., taking over control of one or more control mechanisms, such as the steering, acceleration, or braking systems).

As further provided herein, fully autonomous and/or semi-autonomous vehicle operations require a precisely calibrated sensor system on the vehicle such that the perceived environment is accurately measured. The sensor system can include any combination of LIDAR sensors, image sensors (e.g., individual cameras, binocular cameras, fisheye lens cameras, etc.), radar sensors, ultrasonic sensors, and the like. Each of the sensors are intrinsically and extrinsically calibrated with respect to the vehicle and each other to provide an accurate representation of the vehicle's surrounding environment. When a recalibration event occurs, such as the vehicle experiencing a large shock, certain sensors may become misaligned, malfunction, or experience internal faults. Such misalignments and faults can cause the vehicle to underperform or fail at performing autonomous and/or semi-autonomous tasks, such as SOTIF mitigation measures.

According to examples described herein, an on-board computing system of a vehicle can dynamically monitor the vehicle for shocks, vibrations, collisions, and other forces of variable severity to determine whether one or more of the sensors require intrinsic and/or extrinsic calibration, adjustment, and/or realignment. In various examples, each of the sensor may be mounted to the vehicle using a sensor mount assembly that can be rated for various levels of shocks, jolts, and vibrations that may be experienced by the vehicle. In further examples, the sensors themselves may be rated for various levels of shocks and vibrations.

In certain implementations, the computing system can perform one or more functions described herein using a learning-based approach, such as by executing an artificial neural network (e.g., a recurrent neural network, convolutional neural network, etc.) or one or more machine-learning models to process the surrounding environment of the vehicle as well as other sensor data. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

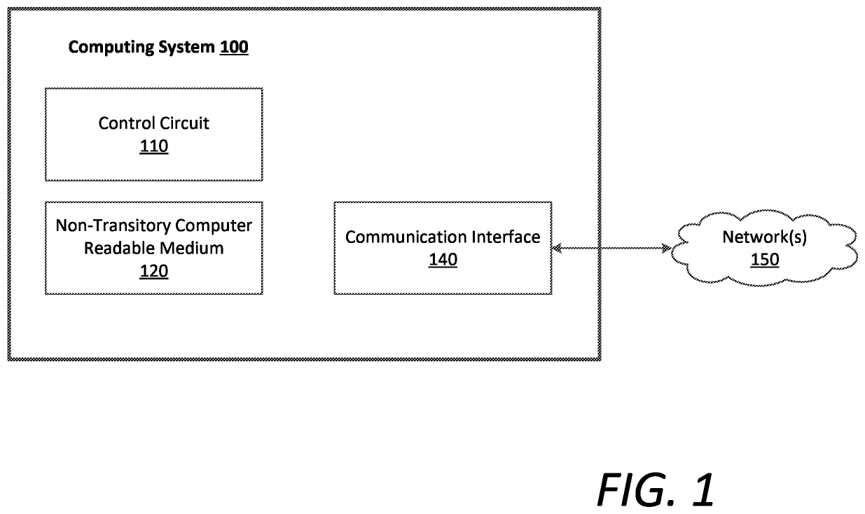

FIG. 1 is a block diagram depicting an example computing system for implementing vehicle safety systems of a vehicle, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”). In variations, the control circuit 110 and/or computing system 100 can be included on one or more servers (e.g., backend servers).

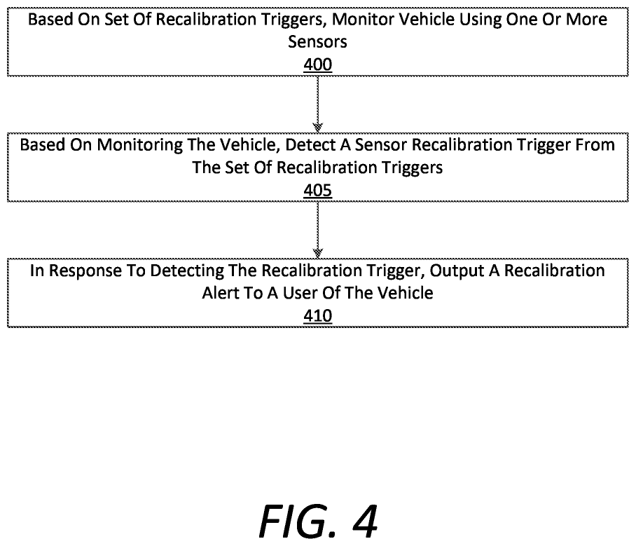

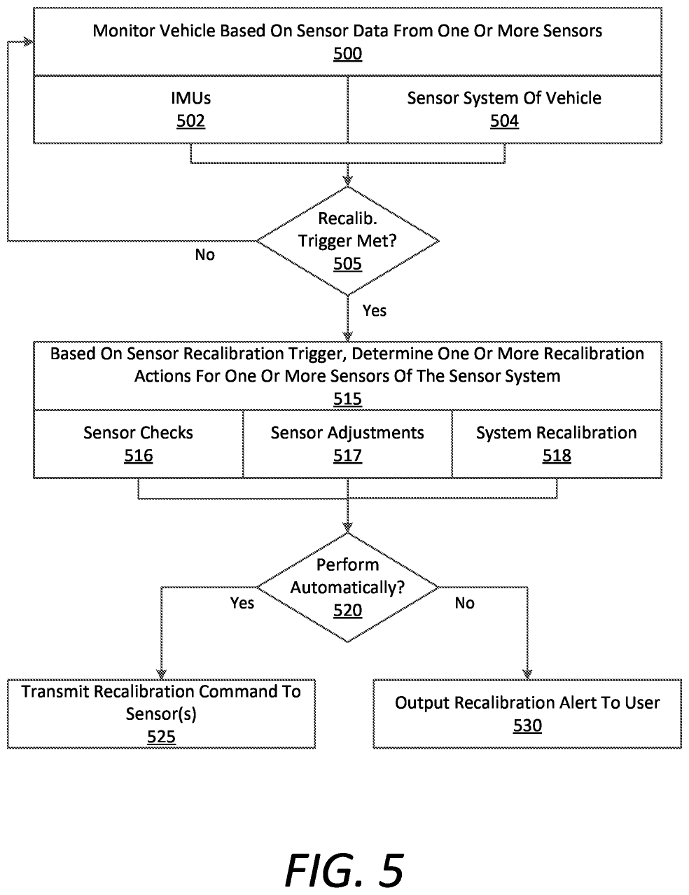

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 4 and 5.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can reside on an on-board vehicle computing system and can receive sensor data from one or more sensors of the vehicle. In certain examples, these sensors can comprise inertial measurement units (IMUs) that include a combination of one or more magnetometers, accelerometers, and/or gyroscopes, and can measure the vehicle's specific force, angular rate, and/or orientation at any given time. In further examples, the computing system 100 can receive sensor data from a sensor system of the vehicle, which can include any combination of LIDAR sensors, image sensors, radar sensors, ultrasonic sensors, and the like.

In various examples, the computing system 100 can monitor the vehicle using the sensor data from one or more of the sensors. Based on monitoring the vehicle, the computing system 100 can determine whether a sensor recalibration trigger has occurred. As provided herein, sensor recalibration triggers can correspond to any shocks or jolts experienced by the vehicle that can cause one or more sensors to require intrinsic and/or extrinsic recalibration. In further aspects, the sensor recalibration triggers can correspond to vehicle component breakage, failure, or replacement (e.g., windshield, side mirrors, rearview mirrors, etc.), and/or can correspond to software or hardware updates on the vehicle. In response to detecting a sensor recalibration trigger, the computing system 100 can output an alert to a user (e.g., an owner or passenger of the vehicle). In certain examples, the recalibration alert can provide a general notification to the user to recalibrate the sensor system of the vehicle. In variations, the recalibration alert can identify the sensor(s) that require recalibration, and/or can provide the user or a technician with contextual information regarding the required recalibration.

### System Description

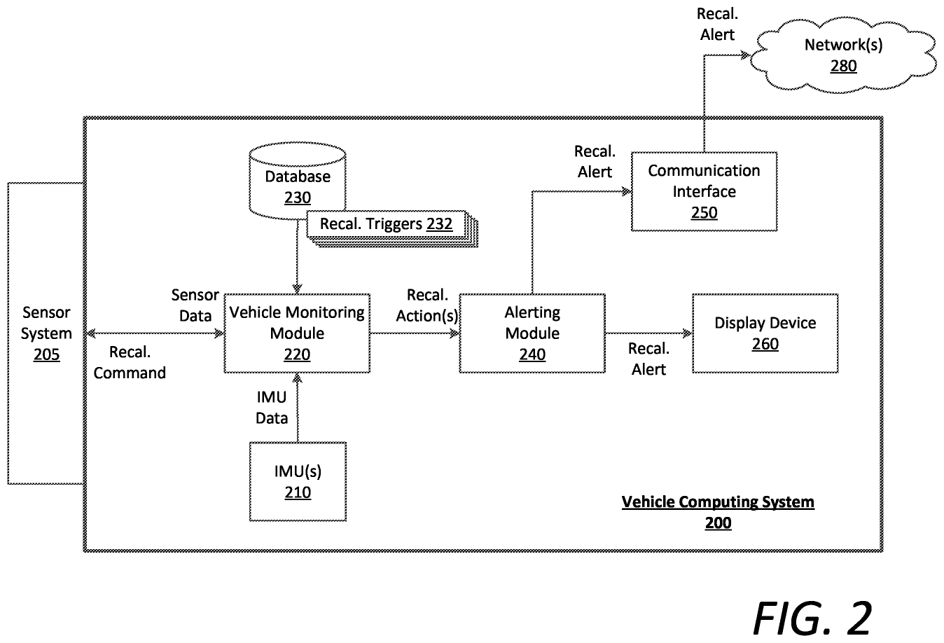

FIG. 2 is a block diagram illustrating an example vehicle computing system including specialized modules for implementing vehicle safety systems, according to examples described herein. In various implementations, the sensor system 205 of the vehicle can include external monitoring sensors, such as radar sensors (e.g., for automated or emergency brake assist), LIDAR sensors and/or cameras (e.g., for environment perception and automated vehicle control), and/or ultrasonic sensors (e.g., for proximity determination). In further implementations, the sensor system 205 can include internal monitoring sensors, such as any combination of global positioning or navigation system sensors, wheel spin sensors, brake force sensors, accelerometers, accelerator pedal position sensors, barometric pressure sensors, tire pressure sensors, fuel temperature sensors, fuel pressure sensors, exhaust temperature sensors, safety system sensors (e.g., indicating performance or any failures of any particular vehicle safety system), coolant and/or water temperature sensors, mass air flow sensors, manifold pressure sensors, turbo boost sensors, air intake temperature sensors, throttle position sensors, oxygen sensors, NOX sensors, etc.

In certain implementations, the vehicle can comprise an autonomous vehicle that navigates a road network based on perception, occupancy grid detection, object detection and classification, motion planning, and/or vehicle control operations. In variations, the vehicle can comprise a semi-autonomous vehicle that utilizes sensor data from the sensor system 205 for automated tasks, such as emergency braking, collision avoidance, automated parking, lane following, and various other operations (e.g., performed by an advanced driver assistance system of the vehicle). In various examples, the vehicle computing system 200 can include a vehicle monitoring module 220 that can process the sensor data from the sensor system 205 to determine whether recalibration or replacement of one or more sensors is needed. As provided herein, the recalibration can comprise intrinsic or extrinsic recalibration. When the vehicle monitoring module 220 detects that a particular sensor of the sensor system 205 requires recalibration, where possible, the vehicle monitoring module 220 can transmit a recalibration command to the particular sensor to cause the sensor to, for example, adjust a set of internal settings to resolve the recalibration accordingly.

In certain implementations, the computing system 200 can include a database 230 that stores any number of preconfigured recalibration triggers 232, which the vehicle monitoring module 220 can reference to determine detect whether a particular recalibration trigger has occurred. The recalibration triggers 232 can comprise specified scenarios, such as the detection of a broken windshield, disconnected sensor, component failure, experienced shocks or jolts to a particular sensor or the vehicle itself, and the like. Various scenarios are contemplated and can be individualized to the parameters of a particular sensor type (e.g., g-force limits for LIDAR sensors), individual sensors (e.g., fisheye lens camera mounted to the rearview mirror), or sensor mounts (e.g., g-force limits for a particular LIDAR sensor mount). Such scenarios can include detected force thresholds on the vehicle, such as g-force thresholds or shock thresholds experienced by the vehicle, component replacement, over-the-air software updates, hardware upgrades and/or downgrades, and the like. As provided herein, any number of recalibration triggers 232 can be stored in the database 230 and referenced by the vehicle monitoring module 220 dynamically.

In various examples, the computing system 200 can include or otherwise monitor IMU data from one or more IMUs 210 of the vehicle. As provided herein, the IMU data can indicate forces (e.g., g-forces and/or shocks) experienced by the vehicle. In some examples, individual sensors or sensor mounts can include one or more IMUs 210 that can provide the IMU data to the vehicle monitoring module 220. In such examples, the vehicle monitoring module 220 can determine whether a particular recalibration trigger 232 has occurred for the individual sensors or sensor mounts based on the IMU data received from the specified co-located IMUs 210. In variations, the vehicle may have a set of one or more IMUs 210 mounted in a predetermined location on the vehicle, which can generally provide IMU data to the vehicle monitoring module 220.

Based on monitoring the IMU data from the one or more IMUs 210 and/or the sensor data from the sensor system 205, the vehicle monitoring module 220 can detect a sensor calibration trigger that corresponds to one or more of the recalibration triggers 232 in the database 230. In response to detecting the sensor calibration trigger, the vehicle monitoring module 220 can determine one or more of the sensors that requires recalibration, and the nature of the recalibration. For example, a detected sensor calibration trigger can correspond to a g-force threshold for one or more sensors or sensor mounts being exceeded. As provided herein, a recalibration action may be associated with the detected sensor calibration trigger depending on the severity of the trigger. For example, when a g-force threshold on the vehicle has been exceeded (e.g., a 20g jolt), a recalibration trigger 232 can indicate that a full system recalibration is required on the vehicle, which can comprise a system check (e.g., all mounts, sensor settings, and current alignments) and the performance of all actions required to recalibrate the sensor system 205 as a whole.

As provided herein, a full system recalibration can correspond to each sensor of the sensor system 205 being checked for internal settings, damage, and internal and/or external alignment. If any settings are out of specification, any damage is detected, or any misalignment is detected, then a technician can resolve the discrepancies to recalibrate the sensor system 205, which can include extrinsic adjustments, internal settings adjustments, sensor replacements, and the like. Upon detection of a recalibration trigger 232, the vehicle monitoring module 220 can transmit one or more recalibration actions corresponding to the matching recalibration trigger(s) to an alerting module 240 of the computing system 200. In certain examples in which a sensor calibration trigger can be resolved directly (e.g., via intrinsic recalibration of a particular sensor), the vehicle monitoring module 220 can transmit a recalibration command to the affected sensor to enable or cause the affected sensor to perform the automatic calibration accordingly.

Based on the recalibration actions that correspond to the matching recalibration trigger, the alerting module 240 generate a recalibration alert for transmission over one or more networks 280 via a communication interface 250 of the computing system, or for display on a display device 260 of the computing system 200 or vehicle. In certain examples, the alerting module 240 can transmit the recalibration alert to a computing device of a user to notify the user that one or more sensors require recalibration. In such examples, the user can be located within the vehicle or can be remote to the vehicle. In either case, the alerting module 240 can specify which specific sensors require recalibration (e.g., by name, identifier, code, etc.), or can generally notify the user to take the vehicle to a service location to perform the recalibration.

It is contemplated that in order to properly perform fully autonomous or semi-autonomous functions, each sensor of the sensor system 205 must be calibrated with respect to the other sensors and with respect to the vehicle itself (e.g., the vehicle's center). Thus, the examples described herein can facilitate rapid recalibration of the vehicle's sensor system 205 to ensure such safety features operate properly. It is further contemplated that the alerting module 240 can further specify which vehicle safety systems and features will not operate properly unless the sensor system is recalibrated. In such examples, these safety systems and features may be listed or described on the display device 260 until the sensor system 205 is recalibrated or reset by a technician.

### Example Recalibration Triggers

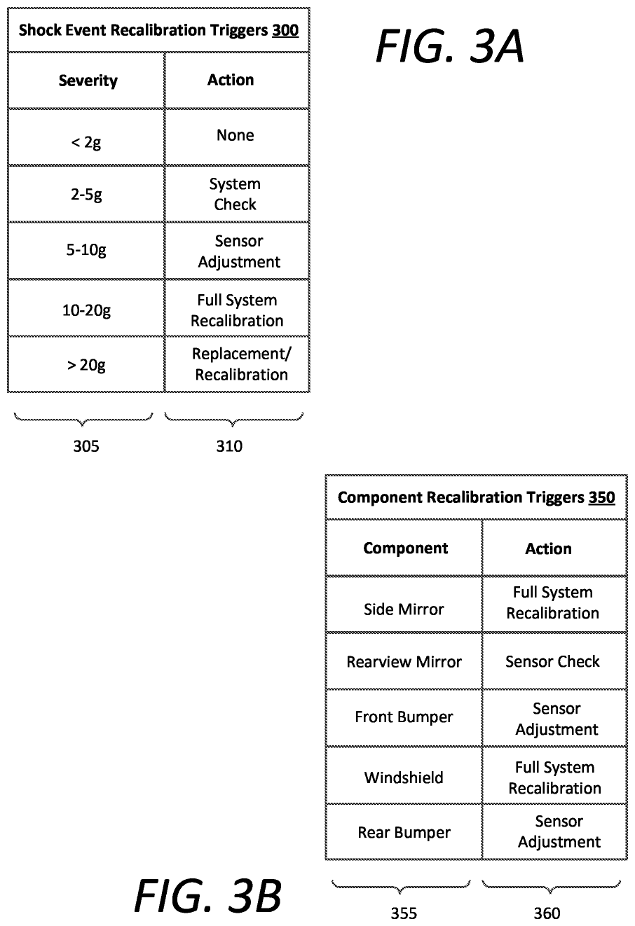

FIGS. 3A and 3B illustrate example recalibration triggers, such as the recalibration triggers 232 as shown and described with respect to FIG. 2, according to examples described herein. As provided herein, the examples shown and described with respect to FIGS. 3A and 3B are for illustrative purposes, and are not intended to limit any embodiments of the present disclosure. Furthermore, while the examples of FIGS. 3A and 3B describe two types of recalibration triggers, numerous recalibration triggers are contemplated, which can involve various levels of severity of forces or jolts experienced on the vehicle, component damage and replacement, or updates to software and/or hardware on the vehicle. Thus, the example recalibration triggers shown in FIGS. 3A and 3B are merely provided for illustration purposes, and do not constitute an exhaustive list of recalibration triggers for the vehicle.

Referring to FIG. 3A, an example list of recalibration triggers 300 are provided for shock events that have varying levels of severity as measured in g-forces. In various implementations, the shock even recalibration triggers 300 can correspond to any acceleration or jerk event experienced by the vehicle as measured by one or more IMUs. In one aspect, the various sensors of the vehicle may include acceleration or shock ratings and/or the mounting mechanisms of the sensors can include acceleration or shock ratings. In further aspects, the shock event recalibration triggers 300 can be configured for a single sensor (e.g., a LIDAR sensor), a single sensor type (e.g., the image sensors of the vehicle), or the entire sensor system 205 of the vehicle.

In the example shown in FIG. 3A, the shock event recalibration triggers 300 are classified based on the severity of the shock event. As shown in the severity column 305, various levels of severity of the shock event are correlated with recalibration actions to be performed, as shown in the recalibration column 310. For the particular sensor, sensor type, or full sensor system, shocks experienced having a severity of less than two g's can be correlated to no action being needed. For example, the sensor, sensor type, and/or sensor system 205 may have internal and external mount ratings that can readily tolerate two g's of force. For two g's to five g's of force, a system check may be required to ensure that no damage has resulted from the experienced shock. As such, a notification may be provided to a user of the vehicle to bring the vehicle to be checked by a technician to perform the system check.

In the example shown in FIG. 3A, from five g's to ten g's of experienced shock, a sensor adjustment may be required for one or more of the sensors of the sensor system 205, which can correspond to one or more individual sensors requiring an adjustment to either an intrinsic or extrinsic parameter. The adjustment may correspond to a sensor setting or a realignment of the sensor with respect to the sensor mount and/or one or more other sensors in the sensor system 205. As further shown in FIG. 3A, an experienced shock between ten g's to twenty g's can involve a full system recalibration, which can correspond to a recalibration of the entire sensor system 205 with respect to the vehicle. As further shown, an experienced shock above twenty g's can correspond to the replacement of one or more sensors as well as a full system recalibration.

FIG. 3B illustrates another example of a set of recalibration triggers that involve component replacements resulting from accidents, collisions, component failures, and/or general breakage of the components. The component recalibration triggers 350 can include a listing of components as shown in column 355, and the recalibration action to be performed as shown in column 360. As shown in column 355, individual components for the vehicle can include the side mirrors, rearview mirror, front and rear bumpers, and windshield, each of which can include one or more sensors and are routinely replaced due to accidents or breakage. Accordingly, the replacement of these components may require certain types of sensor recalibration actions, as listed in column 360.

In the example shown in FIG. 3B, replacement of a side mirror can require a full system recalibration due to, for example, multiple sensor types being housed in the side mirror housings (e.g., radar, proximity, and image sensors). In further examples, replacement of the rearview mirror may simply require a sensor check of the sensor housed in the rearview mirror to ensure alignment (e.g., a fisheye image sensor). In still further examples shown in FIG. 3B, the replacement of the front and/or rear bumper may require sensor adjustments (e.g., due to only radar sensors being housed in the bumpers). The component recalibration triggers 350 can further include a windshield breakage or replacement recalibration trigger, in which a full system recalibration may be required (e.g., due to multiple sensor types having a sensor view through the windshield).

Numerous recalibration triggers are contemplated, which can result from various occurrences experienced by the vehicle, include shock event recalibration triggers 300, component recalibration triggers 350 as shown in FIGS. 3A and 3B, as well as software and hardware update recalibration triggers (e.g., sensor upgrades, sensor downgrades, over-the-air software updates, and the like). Each recalibration trigger can be associated with one or more recalibration actions, which can comprise sensor checks, alignment checks, intrinsic or extrinsic adjustments, partial recalibrations of the sensor system 205 (e.g., image sensors being recalibrated with respect to each other), or a full sensor system recalibration. Accordingly, the recalibration triggers shown in FIGS. 3A and 3B are for illustrative purposes only, and are not intended to be limiting in any manner.

### Methodology

FIGS. 4 and 5 are flow charts describing example methods of implementing vehicle monitoring and sensor recalibration alerts, according to examples described herein. In the below descriptions of FIGS. 4 and 5, reference may be made to reference characters representing various features as shown and described with respect to FIGS. 1 through 3. Furthermore, the processes described in connection with FIGS. 4 and 5 may be performed by an example computing system 200 as described with respect to FIG. 2. Further still, certain steps described with respect to the flow charts of FIGS. 4 and 5 may be performed prior to, in conjunction with, or subsequent to any other step, and need not be performed in the respective sequences shown.

Referring to FIG. 4, at block 400, the vehicle computing system 200 can monitor a vehicle using one or more sensors based on a set of recalibration triggers. As provided herein, the one or more sensors can comprise one or more IMUs of the vehicle, sensors from the sensor system 205 of the vehicle (e.g., LIDAR, image, and/or radar sensors), or sensors that detect that a component has been replaced. At block 405, the computing system 200 can further detect a sensor recalibration trigger from the set of recalibration triggers based on monitoring the vehicle. As described throughout the present disclosure, the sensor recalibration trigger can correspond to a shock or jolt experienced by the vehicle exceeding one or more thresholds (e.g., as determined from IMU data), or can correspond to misalignment events due to physical contact with the sensors or sensor mounts (e.g., based on a collision, bump, accident, or intentional modification of the vehicle).

At block 410, the computing system 200 can output a recalibration alert to a user of the vehicle in response to detecting the recalibration trigger. As provided herein, the recalibration alert can provide the user with an indication that a sensor check, adjustment, and/or recalibration is needed. In further examples, the recalibration alert can indicate which specific sensors require a recalibration check, adjustment, or whether the sensor system requires a full system recalibration. As described herein, the computing system 200 can output the recalibration alert to a display screen of the vehicle, and/or can transmit the recalibration alert to a computing device of the user (e.g., via one or more networks 280, such as a Bluetooth, Wi-Fi, or cellular network).

FIG. 5 is another example method of implementing vehicle monitoring and sensor recalibration alerts, according to various examples. Referring the FIG. 5, at block 500, the computing system 200 of the vehicle can monitor the vehicle based on sensor data from one or more sensors. As described herein, the sensors can comprise one or more IMUs, at block 502, and/or one or more sensors from the sensor system 205 of the vehicle, at block 504. By monitoring the vehicle, the computing system 200 can dynamically determine whether a sensor recalibration trigger has occurred through experienced forces or jolts, component misalignment, damage, replacement, etc.

At decision block 505, the computing system 200 can dynamically determine whether a recalibration trigger has been met. As provided herein, a recalibration trigger can be met if a predetermined condition has occurred on the vehicle, such as a detected force on the vehicle, component damage, misalignment, or replacement, and/or sensor failures or faults. If no recalibration trigger has been met, the computing system 200 continues to dynamically monitor the vehicle. If one or more recalibration triggers have been met, at block 515, the computing system 200 can determine one or more recalibration actions for one or more sensors of the sensor system 205 based on the recalibration trigger.

At block 516, the recalibration actions can correspond to sensor checks, in which the user or a technician determined whether any potentially affected sensors require recalibration. At block 517, the recalibration actions can comprise sensor adjustments, in which the user or a technician can realignment or adjust the settings (e.g., intrinsic or extrinsic settings) of one or more sensors. At block 518, the recalibration actions can correspond to a system recalibration, in which the affected sensors require a full system recalibration with respect to the vehicle and/or the other sensors of the sensor system 205.

In certain scenarios, the potentially affect sensor(s) can be checked, adjusted, or recalibrated automatically. As an example, an image sensor may experience a jolt that has affected the intrinsic parameters of the image sensor. The computing system 200 or the image sensor itself can determine that the image sensor may be intrinsically recalibrated via a recalibration command. As another example, an image sensor or LIDAR sensor may be mounted to the vehicle via a joint operated by an actuator that allows for a certain tolerance level of realignment. If the misalignment caused by the recalibration trigger is within this tolerance level, the computing system 200 or the sensor can automatically realign and/or recalibrate the affected sensor accordingly. Thus, in certain implementations, at decision block 520, the computing system 200 can determine whether the sensor check, adjustment, and/or recalibration can be performed automatically.

In an embodiment, if the sensor check, adjustment, and/or recalibration can be performed automatically, the computing system 200 can transmit a recalibration command to the sensor(s) to facilitate automatic recalibration, at block 525. In variations, the sensor can automatically perform the recalibration action(s) in accordance with the recalibration command. If the recalibration action(s) cannot be performed automatically, the computing system 200 can output a recalibration alert to a user, as described herein.

It is contemplated that the vehicle computing system 200 can comprise a component of an advanced driver assistance system (ADAS) of the vehicle, or can be included as a component of an autonomous vehicle control system that autonomously operates the vehicle along a travel route. It is further contemplated that alignment and calibration of the vehicle's sensor system 205 may be necessary for proper functioning of the vehicle's safety systems. As provided herein, the safety systems of the vehicle can comprise any safety system, such as a brake assist system, an active lane steering assist system, a forward collision warning system, an automatic emergency braking system, a pedestrian detection and/or avoidance system, an adaptive cruise control system, a blind spot warning system, a rear cross-traffic alert system, a lane departure warning system, a lane-keeping assistance system, an active head restraint system, a backup camera system, a parking assistance system, an airbag system, a seat-beat locking system, a traction control system, an electronic stability control system, a collision intervention system, and the like.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system for a vehicle, the computing system comprising:
one or more processors;
a memory storing instructions that, when executed by the one or more processors, cause the computing system to:
based on a set of sensor calibration triggers, monitor the vehicle using one or more sensors;
based on monitoring the vehicle, detect a sensor calibration trigger of the set of sensor calibration triggers; and
in response to detecting the sensor calibration trigger, output a recalibration alert to a user, the recalibration alert notifying the user to recalibrate a sensor system of the vehicle.

2. The computing system of claim 1, wherein each sensor calibration trigger of the set of sensor calibration triggers corresponds to a severity level.

3. The computing system of claim 1, wherein the one or more sensors for monitoring the vehicle comprise one or more inertial measurement units (IMUs).

4. The computing system of claim 1, wherein the sensor system comprises any combination of one or more LIDAR sensors, one or more image sensors, one or more radar sensors, or one or more ultrasonic sensors.

5. The computing system of claim 4, wherein the one or more sensors for monitoring the vehicle are included in the sensor suite.

6. The computing system of claim 1, wherein the set of triggers correspond to a set of scenarios, the set of scenarios comprising at least one of: windshield breakage, windshield replacement, a shock or vibration experienced by the vehicle, an over-the-air update to software, a hardware upgrade, a hardware downgrade, a component adjustment, or a component replacement.

7. The computing system of claim 1, wherein the vehicle comprises an autonomous vehicle or a semi-autonomous vehicle.

8. The computing system of claim 1, wherein the executed instructions further cause the computing system to:
based on monitoring the vehicle, detect a second sensor calibration trigger of the set of sensor calibration triggers, the second sensor calibration trigger corresponding to an intrinsic recalibration of a sensor in the sensor system; and
in response to detecting the second sensor calibration trigger, transmit a calibration command to the sensor to cause the sensor to perform the intrinsic recalibration.

9. The computing system of claim 1, wherein the executed instructions cause the computing system to output the calibration alert to a display screen of the vehicle.

10. A non-transitory computer readable medium storing instructions that, when executed by one or more processors of a computing system of a vehicle, cause the computing system to:
based on a set of sensor calibration triggers, monitor the vehicle using one or more sensors;
based on monitoring the vehicle, detect a sensor calibration trigger of the set of sensor calibration triggers; and
in response to detecting the sensor calibration trigger, output a recalibration alert to a user, the recalibration alert notifying the user to recalibrate a sensor system of the vehicle.

11. The non-transitory computer readable medium of claim 10, wherein each sensor calibration trigger of the set of sensor calibration triggers corresponds to a severity level.

12. The non-transitory computer readable medium of claim 10, wherein the one or more sensors for monitoring the vehicle comprise one or more inertial measurement units (IMUs).

13. The non-transitory computer readable medium of claim 10, wherein the sensor system comprises any combination of one or more LIDAR sensors, one or more image sensors, one or more radar sensors, or one or more ultrasonic sensors.

14. The non-transitory computer readable medium of claim 13, wherein the one or more sensors for monitoring the vehicle are included in the sensor suite.

15. The non-transitory computer readable medium of claim 10, wherein the set of triggers correspond to a set of scenarios, the set of scenarios comprising at least one of: windshield breakage, windshield replacement, a shock or vibration experienced by the vehicle, an over-the-air update to software, a hardware upgrade, a hardware downgrade, a component adjustment, or a component replacement.

16. The non-transitory computer readable medium of claim 10, wherein the vehicle comprises an autonomous vehicle or a semi-autonomous vehicle.

17. The non-transitory computer readable medium of claim 10, wherein the executed instructions further cause the computing system to:
based on monitoring the vehicle, detect a second sensor calibration trigger of the set of sensor calibration triggers, the second sensor calibration trigger corresponding to an intrinsic recalibration of a sensor in the sensor system; and
in response to detecting the second calibration trigger, transmit a calibration command to the sensor to cause the sensor to perform the intrinsic recalibration.

18. The non-transitory computer readable medium of claim 10, wherein the executed instructions cause the computing system to output the calibration alert to a display screen of the vehicle.

19. A computer-implemented method for monitoring a vehicle for sensor recalibration, the method being performed by one or more processors of the vehicle and comprising:
based on a set of sensor calibration triggers, monitoring the vehicle using one or more sensors;
based on monitoring the vehicle, detecting a sensor calibration trigger of the set of sensor calibration triggers; and
in response to detecting the sensor calibration trigger, outputting a recalibration alert to a user, the recalibration alert notifying the user to recalibrate a sensor system of the vehicle.

20. The method of claim 19, wherein each sensor calibration trigger of the set of sensor calibration triggers corresponds to a severity level.
